(19) United States
(12) Patent Application Publication
(10) Pub. No.: US 2026/0261028 A1
(43) Pub. Date: Sep. 3, 2026

(54) ISOLATOR AND METHOD OF MAGNETIZATION FOR ISOLATOR

(71) Applicant: KYOCERA Corporation, Kyoto (JP)

(72) Inventors: Dan MAEDA, Yokohama-shi, Kanagawa (JP); Tomoya SUGITA, Machida-shi, Tokyo (JP); Reona MOTOJI, Minato-ku, Tokyo (JP); Hirotaka UEMURA, Kawasaki-shi, Kanagawa (JP); Naoki MATSUI, Meguro-ku, Tokyo (JP)

(73) Assignee: KYOCERA Corporation, Kyoto (JP)

(21) Appl. No.: 18/714,226

(22) PCT Filed: Oct. 12, 2023
(86) PCT No.: PCT/JP2023/036978

§ 371 Date: May 29, 2024

(51) Int. Cl. H01P 1/36

(52) U.S. Cl. CPC H01P 1/36; G02F 1/093; G02F 1/0955

(57) ABSTRACT

An isolator 10 includes an optical chip 11, a first substrate 12, a first magnetic member 13, and a second magnetic member 14. The optical chip 11 includes a waveguide 16. The waveguide 16 is configured to propagate an electromagnetic wave in an extending direction of the waveguide 16. The optical chip 11 is mounted on the first substrate 12. The first magnetic member 13 is fixed at one side of the waveguide 16 in a first direction. The first direction is perpendicular to the extending direction and is parallel to a main surface of the first substrate 12. The first magnetic member 13 includes at least one magnetic body. The second magnetic member 14 is fixed at the other side of the waveguide 16 in the first direction. The second magnetic member 14 includes at least one magnetic body.

### TECHNICAL FIELD

The present invention relates to an isolator and an isolator magnetization method.

### BACKGROUND OF INVENTION

A known isolator exhibits transmittance that depends on the direction of propagation of an electromagnetic wave. A waveguide type isolator exhibits a magneto-optic effect upon application of a magnetic field to a non-reciprocal member disposed in proximity to a waveguide (refer to Patent Literature 1).

### CITATION LIST

### Patent Literature

Patent Literature 1: International Publication No. 2007-083419

### SUMMARY

### Problem to be Solved

Exhibiting non-reciprocity requires application of a strong magnetic field. Applying a magnetic field externally to a chip including a waveguide has been considered for application of a strong magnetic field. However, application of an external magnetic field to the chip leads to non-uniformity in magnetic field in the chip, causing non-uniformity in magneto-optic effect.

In response to the above issue, the present disclosure provides an isolator that reduces non-uniformity in magneto-optic effect and an isolator magnetization method.

### Solution to Problem

In response to the above issue, a first aspect provides an isolator including an optical chip, a first substrate, a first magnetic member, and a second magnetic member. The optical chip includes a waveguide configured to propagate an electromagnetic wave in an extending direction of the waveguide. The optical chip is mounted on the first substrate. The first magnetic member is fixed at one side of the waveguide in a first direction perpendicular to the extending direction and parallel to a main surface of the first substrate. The first magnetic member includes at least one magnetic body. The second magnetic member is fixed at the other side of the waveguide in the first direction. The second magnetic member includes at least one magnetic body.

A second aspect provides a method of magnetization for an isolator that includes an optical chip including a waveguide configured to propagate an electromagnetic wave in an extending direction of the waveguide, a first substrate on which the optical chip is mounted, a first magnetic member fixed at one side of the waveguide in a first direction perpendicular to the extending direction and parallel to a main surface of the first substrate and including at least one magnetic body, and a second magnetic member fixed at the other side of the waveguide in the first direction and including at least one magnetic body. The method includes magnetizing the first magnetic member and the second magnetic member of the isolator in the first direction.

### BRIEF DESCRIPTION OF THE DRAWINGS

FIG. 1 is a perspective view of an isolator according to a first embodiment.

FIG. 2 is a sectional view of the isolator of FIG. 1 taken along a plane perpendicular to an extending direction.

FIG. 3 is a top plan view of a variation of the isolator of FIG. 1 as viewed in a normal direction that is normal to the isolator.

FIG. 4 is a top plan view of another variation of the isolator of FIG. 1 as viewed in the normal direction.

FIG. 5 is a perspective view of further another variation of the isolator of FIG. 1.

FIG. 6 is a perspective view of still another variation of the isolator of FIG. 1.

FIG. 7 is a sectional view of an isolator according to a second embodiment taken along a plane perpendicular to the extending direction.

FIG. 8 is a sectional view of a variation of the isolator according to the second embodiment taken along a plane perpendicular to the extending direction.

FIG. 9 is a sectional view of a variation of the isolator of FIG. 7 taken along a plane perpendicular to the extending direction.

### DESCRIPTION OF EMBODIMENTS

An isolator according to one or more embodiments of the present disclosure will be described below with reference to the drawings.

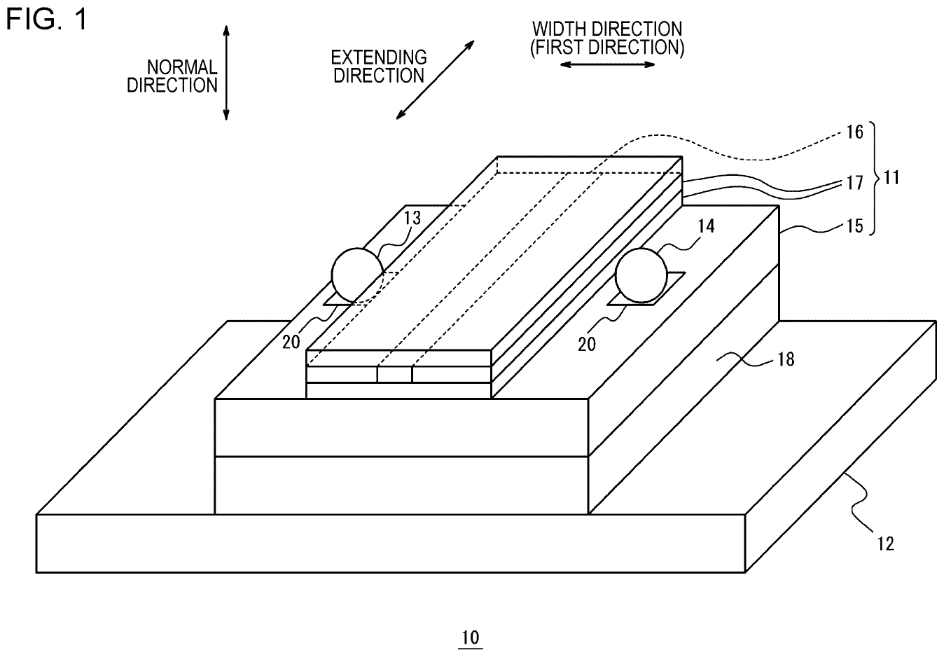

In a first embodiment, as illustrated in FIG. 1, an isolator 10 includes an optical chip 11, a first substrate 12, a first magnetic member 13, and a second magnetic member 14. The isolator 10 may further include a third substrate 18.

The optical chip 11 may include a second substrate 15, a waveguide 16, and an insulating layer 17.

The second substrate 15 may be flat and plate-shaped. The second substrate 15 may be made of a material having a refractive index lower than that of a material forming the waveguide 16. The second substrate 15 is made of, for example, Si.

The waveguide 16 may be stacked directly or indirectly on the second substrate 15. The waveguide 16 may extend along a main surface of the second substrate 15. The main surface is the largest one of multiple flat surfaces defining the second substrate 15. The waveguide 16 propagates an electromagnetic wave in its extending direction.

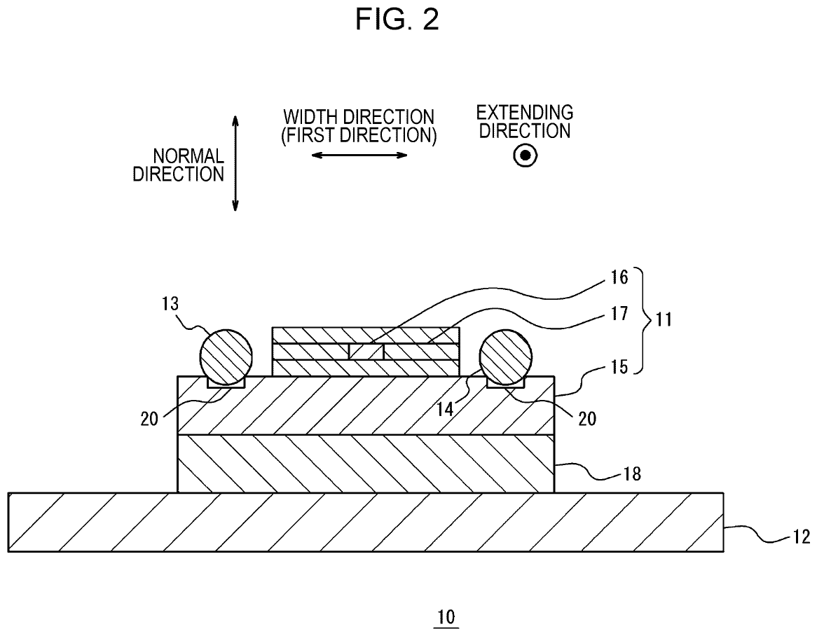

At least part of the waveguide 16 may coincide with the first magnetic member 13 and the second magnetic member 14 in a normal direction that is normal to a main surface of the first substrate 12. In other words, at least part of the waveguide 16 may be at the same level as that at which the first magnetic member 13 and the second magnetic member 14 are located in the normal direction relative to the first substrate 12. Preferably, as illustrated in FIG. 2, the center of the waveguide 16 may be located at the same level as that at which the centers of the first and second magnetic members 13 and 14 are located in the normal direction.

As described above, the waveguide 16 may be made of a material having a refractive index higher than that of the material forming the second substrate 15. The waveguide 16 is made of, for example, Si, SiN, or SiOₓ.

The insulating layer 17 may be located on the main surface of the second substrate 15. The insulating layer 17 may be located around the waveguide 16. Specifically, the insulating layer 17 may be located between the second substrate 15 and the waveguide 16. The insulating layer 17 may be located on opposite sides of the waveguide 16 in a width direction of the waveguide 16. The width direction is a direction perpendicular to the extending direction of the waveguide 16 and the normal direction.

The insulating layer 17 may be made of a material having a refractive index lower than that of the material forming the waveguide 16. The insulating layer 17 is made of, for example, SiO₂, SiOₓ, or SiON.

The first substrate 12 may be flat and plate-shaped. The optical chip 11 is mounted on the first substrate 12. The main surface of the first substrate 12 may be parallel to the main surface of the second substrate 15 in the optical chip 11. The optical chip 11 may be stacked on the first substrate 12 with the third substrate 18 therebetween. The first substrate 12 may be made of any material. For example, the first substrate 12 may be an organic substrate or may be a ceramic substrate. The third substrate 18 may be located between the first substrate 12 and the optical chip 11 and be stacked next to the optical chip 11. The third substrate 18 is a SiO₂ layer, serving as an interposer layer, provided to meet desired requirements.

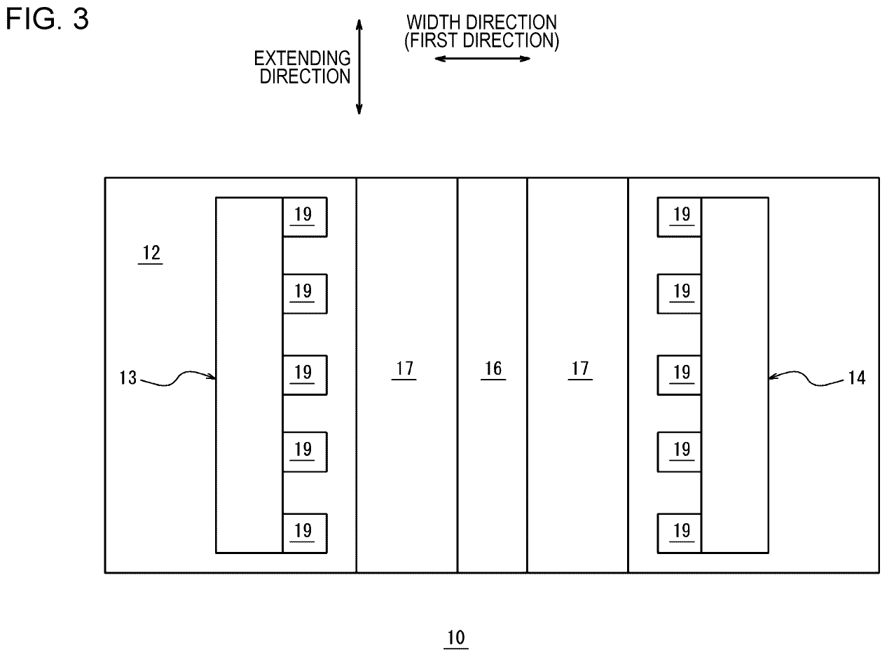

The first magnetic member 13 is fixed at one side of the waveguide 16 in a first direction. The first direction is perpendicular to the extending direction and is parallel to the main surface of the first substrate 12. Therefore, the first direction is parallel to the width direction. The first magnetic member 13 includes at least one magnetic body. In the example illustrated in FIG. 1, the entire first magnetic member 13 is one magnetic body. As illustrated in FIG. 3, the first magnetic member 13 may include multiple magnetic bodies 19. The multiple magnetic bodies 19 may be arranged in the extending direction.

The second magnetic member 14 is fixed at the other side of the waveguide 16 in the first direction. The second magnetic member 14 includes at least one magnetic body. In the example illustrated in FIG. 1, the entire second magnetic member 14 is one magnetic body. As illustrated in FIG. 3, the second magnetic member 14 may include multiple magnetic bodies 19. The multiple magnetic bodies 19 may be arranged in the extending direction.

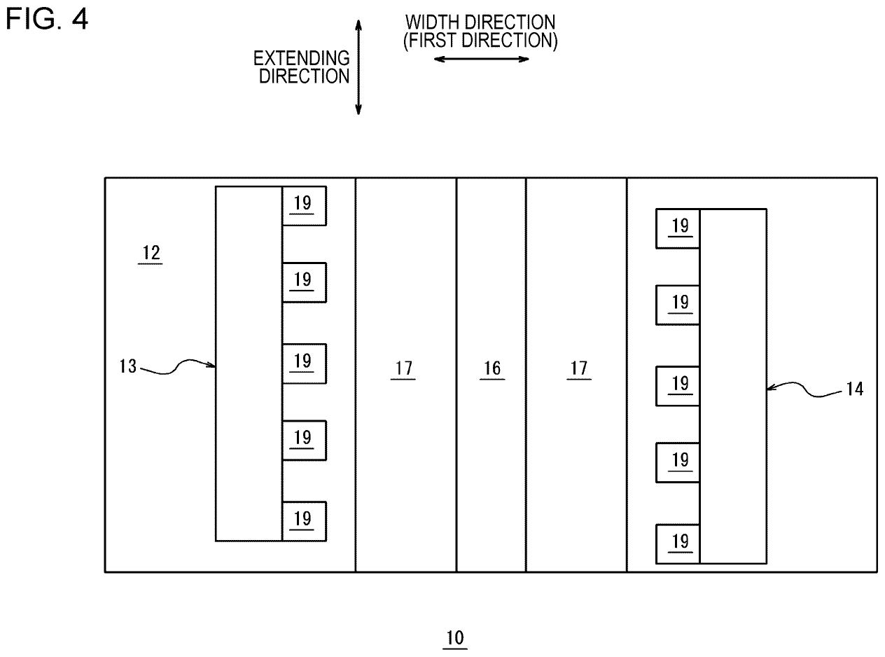

As illustrated in FIGS. 1 and 2, the magnetic body included in the first magnetic member 13 and the magnetic body included in the second magnetic member 14 may be across the waveguide 16 from each other. As illustrated in FIG. 4, which illustrates the first magnetic member 13 and the second magnetic member 14 each including the multiple magnetic bodies 19, the magnetic bodies 19 included in the first magnetic member 13 and the magnetic bodies 19 included in the second magnetic member 14 may be staggered in the extending direction.

The first magnetic member 13 and the second magnetic member 14 may be fixed at the waveguide 16 in a variety of configurations. In the first embodiment, as illustrated in FIG. 1, the first magnetic member 13 and the second magnetic member 14 may be fixed to, for example, recesses 20 formed in the second substrate 15. For example, an adhesive or a covering may be used to fix the magnetic members to the recesses 20.

In the first embodiment, the magnetic body included in each of the first magnetic member 13 and the second magnetic member 14 may be spherical. In the configuration in which the whole of each of the first magnetic member 13 and the second magnetic member 14 is a magnetic body, the first magnetic member 13 and the second magnetic member 14 may be spherical. In such a configuration in which the first magnetic member 13 and the second magnetic member 14 are spherical, the recesses 20 may have a square pyramid shape or a rectangular cuboid shape. The recess 20 having a square pyramid shape means that the shape of a hollow defined by the recess 20 is a square pyramid. The recess 20 having a rectangular cuboid shape means that the shape of a hollow defined by the recess 20 is a rectangular cuboid.

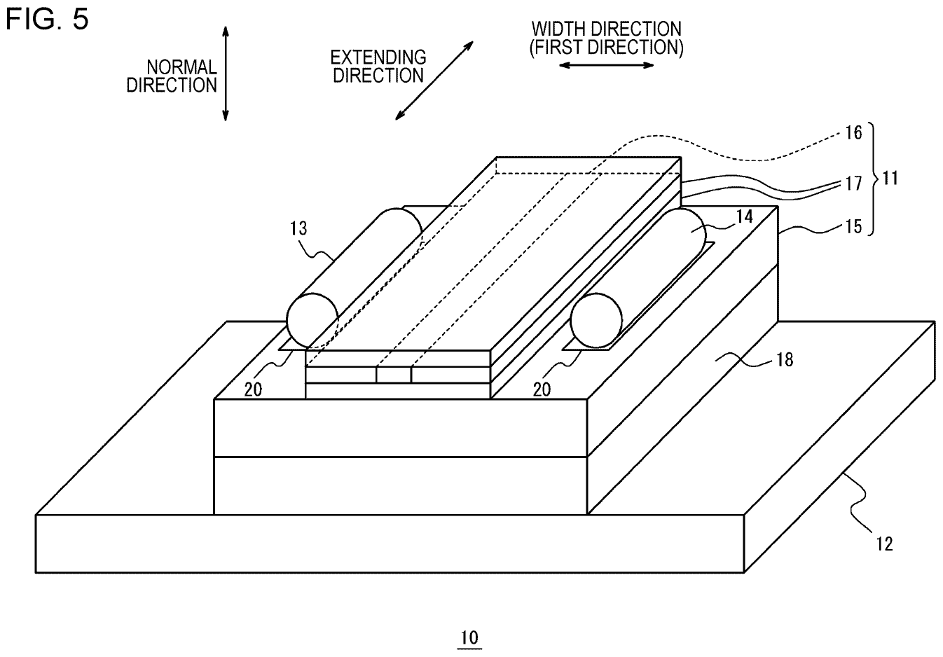

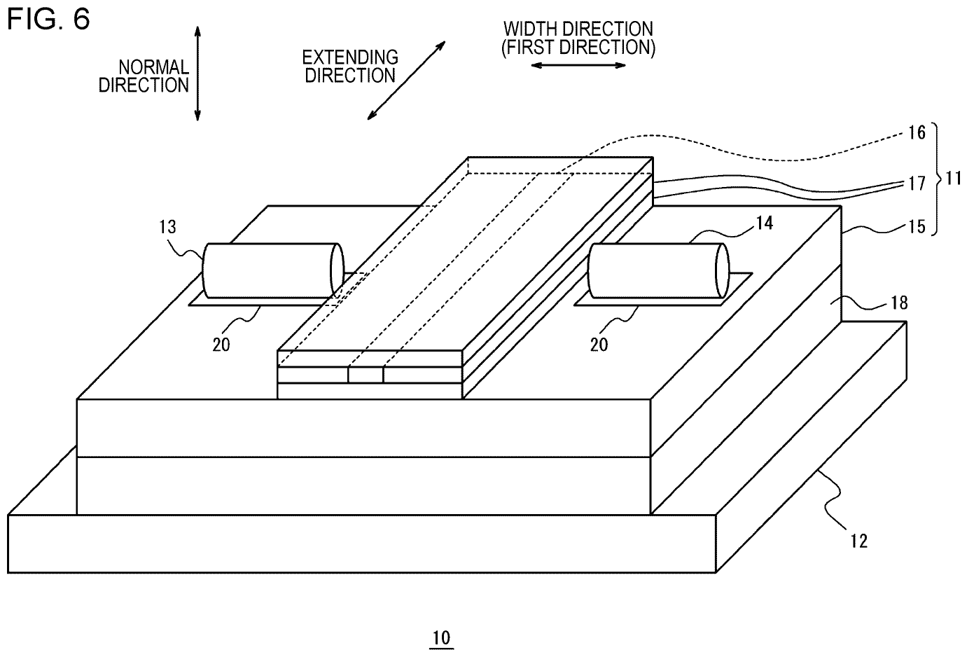

In the first embodiment, as illustrated in FIGS. 5 and 6, the magnetic body included in each of the first magnetic member 13 and the second magnetic member 14 may be rod-shaped. In the configuration in which the whole of each of the first magnetic member 13 and the second magnetic member 14 is a magnetic body, the first magnetic member 13 and the second magnetic member 14 may be rod-shaped. In such a configuration in which the first magnetic member 13 and the second magnetic member 14 are rod-shaped, as illustrated in FIG. 5, each of the recesses 20 may be a groove extending in the extending direction. In the configuration in which the first magnetic member 13 and the second magnetic member 14 are rod-shaped, as illustrated in FIG. 6, each of the recesses 20 may be a groove extending in a direction (width direction) perpendicular to the extending direction. The groove-like recess 20 may be V-shaped or rectangular in cross section.

The orientation of a magnetic field generated by the first magnetic member 13 and the second magnetic member 14 may be substantially aligned with the first direction (width direction). The isolator 10 does not need to undergo magnetization before installed in a target. The first magnetic member 13 and the second magnetic member 14 may be magnetized in the first direction (width direction) after the isolator 10 is installed in the target.

The isolator 10 may be produced in such a manner that the recesses 20 are formed in the second substrate 15 by wet etching, an adhesive is applied to the recesses 20, the first magnetic member 13 and the second magnetic member 14 are positioned in the recesses 20, and the adhesive is hardened.

In the first embodiment, the isolator 10 with the above-described configuration includes the optical chip 11, the first substrate 12, the first magnetic member 13, and the second magnetic member 14. The optical chip 11 includes the waveguide 16 configured to propagate an electromagnetic wave in the extending direction. The optical chip 11 is mounted on the first substrate 12. The first magnetic member 13 is fixed at one side of the waveguide 16 in the first direction perpendicular to the extending direction and parallel to the main surface of the first substrate 12 and includes at least one magnetic body. The second magnetic member 14 is fixed at the other side of the waveguide 16 in the first direction and includes at least one magnetic body. Such a configuration, in which the waveguide 16 is located between the first magnetic member 13 and the second magnetic member 14 in the first direction, of the isolator 10 can reduce non-uniformity in magneto-optic effect. The isolator 10 requires no application of an external magnetic field. This can reduce the size of a device including the isolator 10.

In the first embodiment, the isolator 10 may be configured such that at least part of the waveguide 16 coincides with the first magnetic member 13 and the second magnetic member 14 in the direction normal to the main surface of the first substrate 12. Such a configuration of the isolator 10 can allow the waveguide 16 to be located in a high magnetic flux density region between the first magnetic member 13 and the second magnetic member 14. This configuration of the isolator 10 can apply a large magnetic field to the waveguide 16.

In the first embodiment, the isolator 10 may be configured such that the magnetic body included in the first magnetic member 13 and the magnetic body included in the second magnetic member 14 are across the waveguide 16 from each other. Such a configuration of the isolator 10 can maximize a magnetic field that is applied to the waveguide 16.

In the first embodiment, the isolator 10 may be configured such that the magnetic bodies 19 included in the first magnetic member 13 and arranged in the extending direction and the magnetic bodies 19 included in the second magnetic member 14 and arranged in the extending direction are staggered in the extending direction while being located at opposite sides of the waveguide 16. Such a configuration of the isolator 10 can apply a relatively large magnetic field to the waveguide 16 in a longer region along the extending direction and make a magnetic flux density more uniform in the extending direction. A uniform magnetic flux density in the isolator 10 facilitates simulation analysis, thus allowing the performance of the isolator 10 to be easily expected. Since the isolator 10 exhibits a uniform magnetic flux density, the magnetic flux density can be averaged if a manufacturing problem sporadically occurs in the waveguide 16.

In the first embodiment, the isolator 10 may be configured such that the first magnetic member 13 and the second magnetic member 14 are fixed to the recesses 20 formed in the second substrate 15, which is included in the optical chip 11 and on which the waveguide 16 is stacked. Such a configuration of the isolator 10 can eliminate the need for placement of the first and second magnetic members 13 and 14 on a different substrate for fixing the first and second magnetic members 13 and 14 or the need for the different substrate.

In the first embodiment, the isolator 10 may be configured such that the magnetic body included in each of the first magnetic member 13 and the second magnetic member 14 is spherical and each of the recesses 20 has a square pyramid shape or a rectangular cuboid shape. Such a configuration of the isolator 10 can allow the magnetic body to be rolled on the second substrate 15 and be caught by the recess 20 during manufacturing. Thus, the magnetic body can be easily positioned with high accuracy.

In the first embodiment, the isolator 10 may be configured such that the magnetic body included in each of the first magnetic member 13 and the second magnetic member 14 is rod-shaped and each of the recesses 20 is a groove extending in the extending direction or the direction perpendicular to the extending direction. Such a configuration of the isolator 10 can allow the magnetic body to be rolled on the second substrate 15 and be caught by the recess 20 during manufacturing. Thus, the magnetic body can be easily positioned with high accuracy.

In the first embodiment, a method of magnetization for the isolator 10 includes magnetizing the first magnetic member 13 and the second magnetic member 14 of the isolator 10 in the first direction. The isolator 10 is intended to be installed in a variety of devices. An element other than the isolator 10 can be installed in a target device in which the isolator 10 is to be installed. If the isolator 10 to be installed in the target device included a magnetized magnetic body, a magnetic force might reduce workability during installation of the isolator 10 and another element in the target device. In contrast, the above-described magnetization method can decrease a reduction in workability because magnetization is performed after the isolator 10 is installed in a target. If the first magnetic member 13 and the second magnetic member 14 magnetized in advance were positioned on the second substrate 15, the magnetic members would exert magnetic forces on each other, thus interfering with accurate positioning. In contrast, the above-described magnetization method can allow the first magnetic member 13 and the second magnetic member 14 to be easily fixed at accurate positions.

A second embodiment of the present disclosure will now be described. The second embodiment differs from the first embodiment in the configuration for fixing the first and second magnetic members. The following description will focus on the difference between the second embodiment and the first embodiment. The same component as that in the first embodiment is assigned the same reference sign.

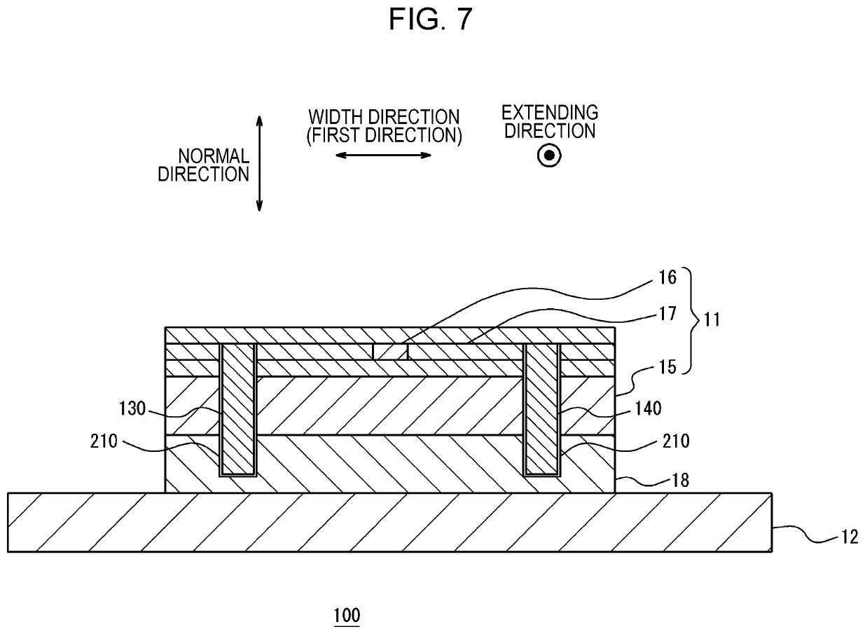

In the second embodiment, as illustrated in FIG. 7, an isolator 100 includes the optical chip 11, the first substrate 12, a first magnetic member 130, and a second magnetic member 140. The structures and functions of the optical chip 11, the first substrate 12, and the third substrate 18 are the same as those in the first embodiment.

The first magnetic member 130 is fixed at one side of the waveguide 16 in the first direction as in the first embodiment. The first magnetic member 130 includes at least one magnetic body as in the first embodiment. The second magnetic member 140 is fixed at the other side of the waveguide 16 in the first direction as in the first embodiment. The second magnetic member 14 includes at least one magnetic body as in the first embodiment.

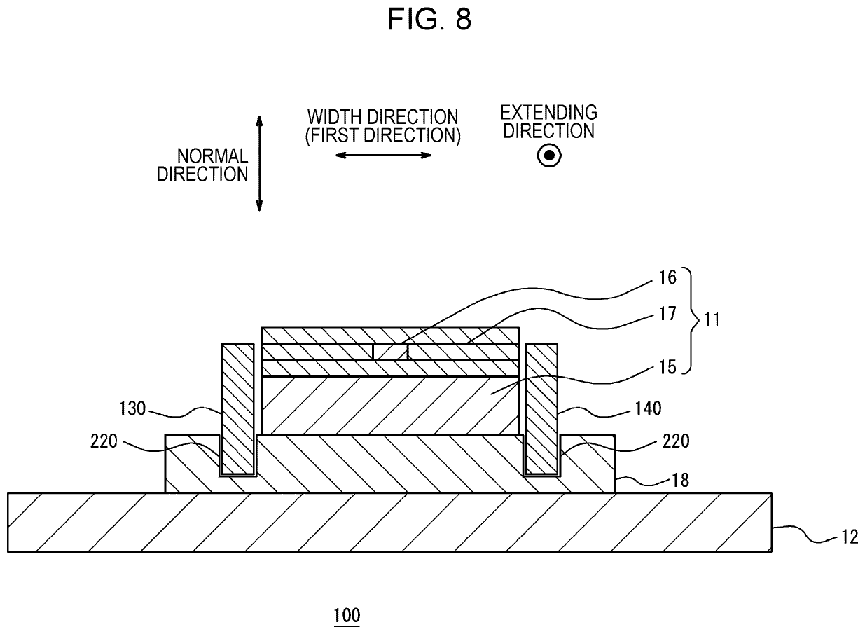

The first magnetic member 130 and the second magnetic member 140 may be fixed to at least the third substrate 18, unlike the magnetic members in the first embodiment. For example, as illustrated in FIG. 7, the first magnetic member 130 and the second magnetic member 140 may be fixed to holes 210 extending from the optical chip 11 into the third substrate 18. For example, as illustrated in FIG. 8, the first magnetic member 130 and the second magnetic member 140 may be fixed to recesses 220 formed in the third substrate 18. For example, an adhesive or a covering may be used to fix the magnetic members to the holes 210 or the recesses 220.

In the second embodiment, the isolator 100 with the above-described configuration also includes the optical chip 11, the first substrate 12, the first magnetic member 130, and the second magnetic member 140. The optical chip 11 includes the waveguide 16 configured to propagate an electromagnetic wave in the extending direction. The optical chip 11 is mounted on the first substrate 12. The first magnetic member 130 is fixed at one side of the waveguide 16 in the first direction perpendicular to the extending direction and parallel to the main surface of the first substrate 12 and includes at least one magnetic body. The second magnetic member 140 is fixed at the other side of the waveguide 16 in the first direction and includes at least one magnetic body. Such a configuration of the isolator 100 can also reduce non-uniformity in magneto-optic effect. The isolator 100 can also allow a reduction in size of a device including the isolator 100.

In the second embodiment, the isolator 100 may also be configured such that at least part of the waveguide 16 coincides with the first magnetic member 130 and the second magnetic member 140 in the direction normal to the main surface of the first substrate 12. Such a configuration of the isolator 100 can also apply a large magnetic field to the waveguide 16.

In the second embodiment, the isolator 100 may also be configured such that the magnetic body included in the first magnetic member 130 and the magnetic body included in the second magnetic member 140 are across the waveguide 16 from each other. Such a configuration of the isolator 100 can also maximize a magnetic field that is applied to the waveguide 16.

In the second embodiment, the isolator 100 may also be configured such that the multiple magnetic bodies 19 included in the first magnetic member 130 and arranged in the extending direction and the multiple magnetic bodies 19 included in the second magnetic member 140 and arranged in the extending direction are staggered in the extending direction while being located at opposite sides of the waveguide 16. Such a configuration of the isolator 100 can also apply a relatively large magnetic field to the waveguide 16 in a longer region along the extending direction and make a magnetic flux density more uniform in the extending direction. A uniform magnetic flux density in the isolator 100 also facilitates simulation analysis, thus allowing the performance of the isolator 100 to be easily expected. Since the isolator 10 also exhibits a uniform magnetic flux density, the magnetic flux density can be averaged if a manufacturing problem sporadically occurs in the waveguide 16.

In the second embodiment, the isolator 100 may be configured such that the first magnetic member 130 and the second magnetic member 140 are fixed to the holes 210 extending from the optical chip 11 into the third substrate 18 stacked next to the optical chip 11. Such a configuration can allow the isolator 100 to include the first magnetic member 130 and the second magnetic member 140 each having a large volume. Therefore, the isolator 100 can allow the first magnetic member 130 and the second magnetic member 140 to exert a large magnetic force.

In the second embodiment, the isolator 100 may be configured such that the first magnetic member 130 and the second magnetic member 140 are fixed to the recesses 220 formed in the third substrate 18 stacked next to the optical chip 11. Such a configuration can allow the isolator 100 to include the first magnetic member 130 and the second magnetic member 140 each having a large volume. Therefore, the isolator 100 can allow the first magnetic member 130 and the second magnetic member 140 to exert a large magnetic force.

The figures illustrating the embodiments of the present disclosure are schematic. For example, a dimensional ratio in the figures does not necessarily match the actual one.

While the embodiments of the present disclosure have been described with reference to the drawings and examples, it should be noted that those skilled in the art can easily make a variety of variations and alterations based on the present disclosure. Therefore, it should be noted that these variations and alterations are included in the scope of the present disclosure. For example, functions included in each component, step, or the like can be reordered in any logically consistent manner. For example, a plurality of components, steps, or the like can be combined into one or divided.

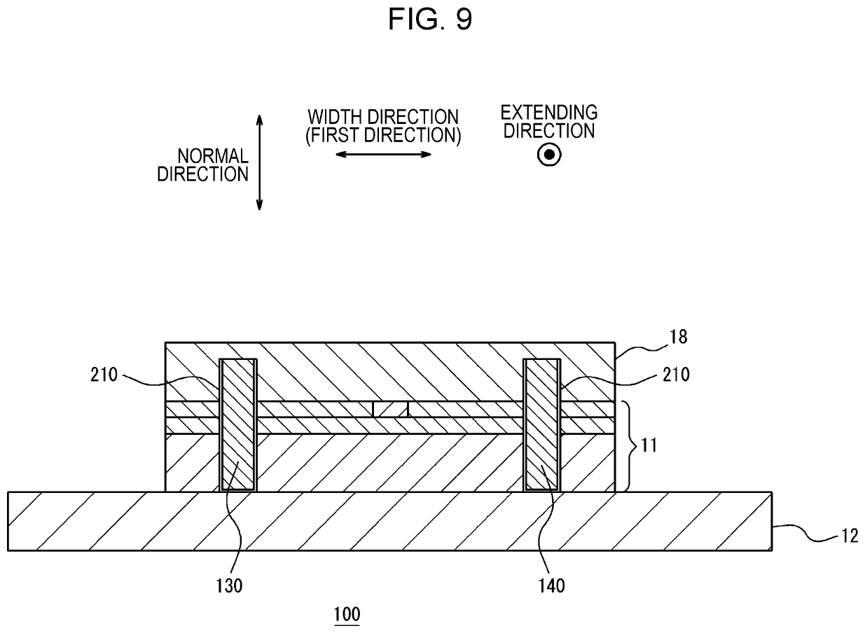

For example, in the second embodiment, the third substrate 18 is located between the first substrate 12 and the optical chip 11. The third substrate 18 needs only to be located next to the optical chip 11. For example, as illustrated in FIG. 9, the third substrate 18 may be located on the opposite side of the optical chip 11 from the first substrate 12 and be next to the optical chip 11. The first magnetic member 130 and the second magnetic member 140 may be fixed to the holes 210 extending through the optical chip 11 into the third substrate 18.

For example, in the second embodiment, the first magnetic member 130 and the second magnetic member 140 are fixed to the recesses 220 formed in the third substrate 18. The first magnetic member 130 and the second magnetic member 140 may be fixed to recesses formed in the first substrate 12.

In the present disclosure, the terms “first”, “second”, and the like are identifiers to distinguish between the components. In the present disclosure, the identifiers representing numbers for the components distinguished with the terms “first”, “second”, and the like are interchangeable. For example, the identifier “first” of a first mask layer is interchangeable with the identifier “second” of a second mask layer. The identifiers are interchanged simultaneously. After the identifiers are interchanged, the components are distinguished from each other. The identifiers may be removed. The components without the identifiers are distinguished from each other by using reference signs. In the present disclosure, the description of identifiers such as “first” and “second” should not be used as a basis for interpreting the order of the components or the existence of identifiers representing smaller numbers.

### REFERENCE SIGNS

10, 100 isolator
11 optical chip
12 substrate
13, 130 first magnetic member
14, 140 second magnetic member
15 second substrate
16 waveguide
17 insulating layer
18 third substrate
19 magnetic body
20 recess
210 hole
220 recess

1. An isolator comprising:
an optical chip comprising a waveguide configured to propagate an electromagnetic wave in an extending direction of the waveguide;
a first substrate on which the optical chip is mounted;
a first magnetic member fixed at one side of the waveguide in a first direction perpendicular to the extending direction and parallel to a main surface of the first substrate, the first magnetic member including at least one magnetic body; and
a second magnetic member fixed at an other side of the waveguide in the first direction, the second magnetic member including at least one magnetic body.

2. The isolator according to claim 1, wherein at least part of the waveguide coincides with the first magnetic member and the second magnetic member in a direction normal to the main surface of the first substrate.

3. The isolator according to claim 1, wherein the at least one magnetic body included in the first magnetic member and the at least one magnetic body included in the second magnetic member are across the waveguide from each other.

4. The isolator according to claim 1, wherein the at least one magnetic body included in the first magnetic member comprises a plurality of magnetic bodies arranged in the extending direction, the at least one magnetic body included in the second magnetic member comprises a plurality of magnetic bodies arranged in the extending direction, and the plurality of magnetic bodies included in the first magnetic member and the plurality of magnetic bodies included in the second magnetic member are staggered in the extending direction while being located at opposite sides of the waveguide.

5. The isolator according to claim 1, wherein the first magnetic member and the second magnetic member are fixed to holes extending from the optical chip into a third substrate stacked next to the optical chip.

6. The isolator according to claim 1, wherein the first magnetic member and the second magnetic member are fixed to recesses formed in a third substrate stacked next to the optical chip.

7. The isolator according to claim 1, wherein the first magnetic member and the second magnetic member are fixed to recesses formed in the first substrate.

8. The isolator according to claim 1, wherein the first magnetic member and the second magnetic member are fixed to recesses formed in a second substrate that is included in the optical chip and on which the waveguide is stacked.

9. The isolator according to claim 8,
wherein the at least one magnetic body included in the first magnetic member and the at least one magnetic body included in the second magnetic member are spherical, and
wherein each of the recesses has a square pyramid shape or a rectangular cuboid shape.

10. The isolator according to claim 8,
wherein the at least one magnetic body included in the first magnetic member and the at least one magnetic body included in the second magnetic member are rod-shaped, and
wherein each of the recesses is a groove extending in the extending direction or a direction perpendicular to the extending direction.

11. An isolator magnetization method comprising:
magnetizing the first magnetic member and the second magnetic member of the isolator according to claim 1 in the first direction.
